(19) United States
(12) Patent Application Publication
(10) Pub. No.: US 2024/0121853 A1
(43) Pub. Date: Apr. 11, 2024

(54) MEASUREMENT REPORT METHOD AND APPARATUS FOR PATH SWITCHING IN A WIRELESS COMMUNICATION SYSTEM

(71) Applicant: Samsung Electronics Co., Ltd., Suwon-si (KR)

(72) Inventors: Jeongseok YU, Suwon-si (KR); Hyunjeong KANG, Suwon-si (KR); Anil AGIWAL, Suwon-si (KR)

(21) Appl. No.: 18/481,436

(22) Filed: Oct. 5, 2023

(30) Foreign Application Priority Data
Oct. 7, 2022 (KR) 10-2022-0128724

(51) Int. Cl. H04W 76/20; H04W 24/10

(52) U.S. Cl. CPC H04W 76/20; H04W 24/10; H04W 92/18

(57) ABSTRACT

The disclosure relates to a 5^{th} generation (5G) or 6^{th} generation (6G) communication system for supporting a higher data transmission rate. A method performed by a base station (BS) in a wireless communication system is provided. The method includes transmitting, to a user equipment (UE), a radio resource control (RRC) message including measurement configuration information through a direct path or an indirect path via a relay UE, and receiving, from the UE, a MeasurementReport message including measurement result through the direct path or the indirect path via the relay UE. Further, the measurement result includes a first measurement result for direction communications (PC5) link and a second measurement result for Uu link.

### CROSS-REFERENCE TO RELATED APPLICATION(S)

This application is based on and claims priority under 35 U.S.C. § 119(a) of a Korean patent application number 10-2022-0128724, filed on Oct. 7, 2022, in the Korean Intellectual Property Office, the disclosure of which is incorporated by reference herein in its entirety.

### BACKGROUND

### 1. Field

The disclosure relates to a wireless communication system (or a mobile communication system). More particularly, the disclosure relates to an enhanced measurement reporting method and apparatus for path switching in a wireless communication system.

### 2. Description of Related Art

5^{th} generation (5G) mobile communication technologies define broad frequency bands such that high transmission rates and new services are possible, and can be implemented not only in “Sub 6 giga hertz (GHz)” bands, such as 3.5 GHz, but also in “Above 6 GHz” bands referred to as mmWave including 28 GHz and 39 GHz. In addition, it has been considered to implement 6^{th} generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEG) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for transmitting a measurement report message for a path switch in a wireless communication system, so as to efficiently provide a path switching procedure between different base stations.

Additional aspects will be set forth in part in the description which follows and, in part, will be apparent from the description, or may be learned by practice of the presented embodiments.

In accordance with an aspect of the disclosure, a method performed by a base station (BS) in a wireless communication system is provided. The method includes transmitting, to a user equipment (UE), a radio resource control (RRC) message including measurement configuration information through a direct path or an indirect path via a relay UE, and receiving, from the UE, a MeasurementReport message including measurement result through the direct path or the indirect path via the relay UE. Further, the measurement result includes a first measurement result for direction communications (PC5) link and a second measurement result for Uu link.

Another aspect of the disclosure is to provide an enhanced measurement reporting method and apparatus for a path switch in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a user equipment (UE)-to-network relay in a wireless communication system according to an embodiment of the disclosure;

FIG. 2 illustrates a discovery message transmission or reception configuration in UE-to-network relay in a wireless communication system according to an embodiment of the disclosure;

FIG. 3 illustrates configuring a direct path and an indirect path of UE-to-network relay according to an embodiment of the disclosure;

FIG. 4A illustrates a base station configuring a measurement configuration with respect to a UE-to-network (U2N) remote UE and receives a measurement report according to an embodiment of the disclosure;

FIG. 4B illustrates additional information in a measurement report and transmitting the same according to an embodiment of the disclosure;

FIG. 4C illustrates operation of measurement reporting by a layer 2 (L2) U2N remote UE according to an embodiment of the disclosure;

FIG. 5A illustrates an inter-base station path switching in UE-to-network relay according to an embodiment of the disclosure;

FIG. 5B illustrates an inter-base station path switching in UE-to-network relay according to an embodiment of the disclosure;

FIG. 6 is a diagram illustrating a structure of a base station according to an embodiment of the disclosure; and

FIG. 7 is a diagram illustrating a structure of a UE according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

The following description of embodiments of the disclosure is mainly directed to new radio (NR) as a radio access network and packet core 5G system or 5G core network or next generation core (NG Core) as a core network in the 5G mobile communication standards specified by the 3^{rd} generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

Various embodiments of the disclosure describe a method in which, in a sidelink user equipment (UE)-to-network relay structure, a UE-to-network remote UE simultaneously transmits a signal intensity measurement result associated with a UE-to-network relay UE, which may be an object to which the path is switchable, and a signal intensity measurement result associated with another base station, which may be an object to which the path is switchable. In addition, a description is provided in association with a method in which a base station that receives a signal intensity measurement result determines path switching for direct communication or path switching for indirect communication via a UE-to-network relay UE, or a method in which a base station that receives a signal intensity measurement result transmits the signal intensity measurement result to another base station that may be an object to which the path is switchable via an inter-base station message.

According to various embodiments of the disclosure, a description is provided in association with a method in which a base station that receives a signal intensity measurement result effectively determines path switching for direct communication via an inter-base station message or path switching for indirect communication via a UE-to-network relay UE.

According to various embodiments of the disclosure, a UE may simultaneously transmit a signal intensity measurement result associated with a UE-to-network relay UE, which may be an object to which the path is switchable, and a signal intensity measurement result associated with another base station, which may be an object to which the path is switchable, and may effectively determine path switching for direct communication with a base station via inter-base station message transmission or path switching for indirect communication via a UE-to-network relay UE.

In the disclosure, the operation of a base station and the operation of a UE according to various embodiments will be described.

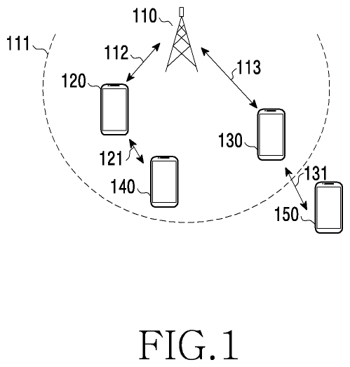

FIG. 1 is a diagram illustrating a user equipment (UE)-to-network relay in a wireless communication system according to an embodiment of the disclosure.

Referring to FIG. 1, a UE-to-network (U2N) Relay UE 120 and 130 is illustrated, which is capable of supporting the operation of a U2N Relay UE. The U2N Relay UE 120 and 130 may be located in an coverage area 111 of a base station 110, which corresponds to an in-coverage (IC) case. In addition, FIG. 1 illustrates a U2N Remote UE 140 and 150 that is capable of supporting the operation of a U2N Remote UE. In the case of in-coverage (IC), the U2N Remote UE 140 and 150 is located in the coverage area 111 of the base station 110. In the case of out-of-coverage (OOC), the U2N Remote UE 140 and 150 is not located in the coverage area 111 of the base station 110. The U2N Remote UEs 140 and 150 may be sidelink UEs.

In addition, uplinks and downlinks 112 and 113 between the base station 110 and the UEs 120 and 130 may be referred to as Uu interfaces, and the transmission links or reception links 121 and 131 with the sidelink UEs 140 and 150 may be referred to as PC5 interfaces. Hereinafter, the uplinks or downlinks 112 and 113 may be interchangeably used with Uu interfaces, and the transmission links or reception links 121 and 131 between the sidelink UEs may be interchangeably used with PC5 interfaces. In case that data transmitted from the base station 110 to the U2N Relay UE 120 and 130 via a Uu link 112 and 113 according to the configuration of the base station 110 is data to be relayed to the U2N Remote UE 140 and 150, the U2N Relay UE 120 and 130 may transmit the data to the U2N Remote UE 140 and 150 via the PC5 link 121 and 131. In addition, the data transmitted from the U2N Remote UE 140 and 150 to the U2N Relay UE 120 and 130 via the PC5 link 121 and 131 is data to be relayed to the base station 110, the U2N Relay UE 120 and 130 may transmit the data transmitted from the U2N Remote UE 140 and 150 to the base station 110 via the Uu link 112 and 113.

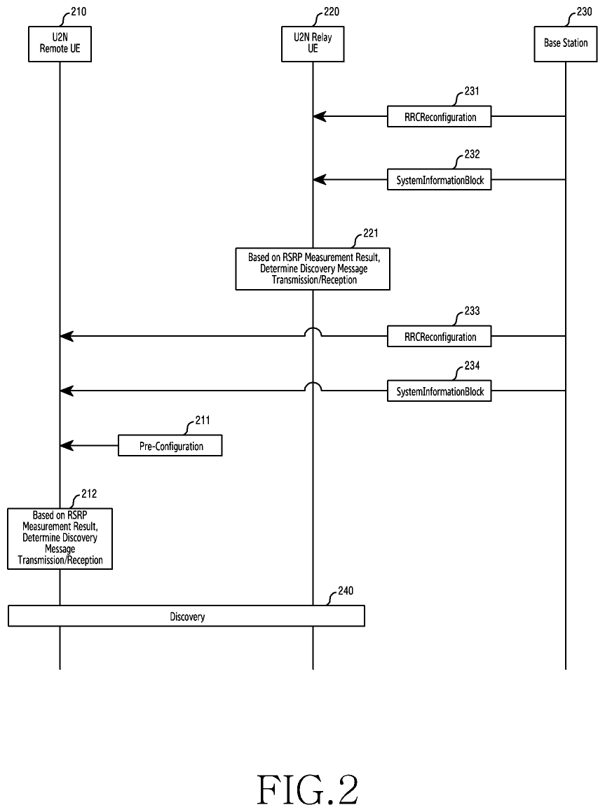

FIG. 2 is a diagram illustrating a discovery message transmission or reception configuration in UE-to-network relay in a wireless communication system according to an embodiment of the disclosure.

Referring to FIG. 2, a base station may transmit a dedicated configuration for sidelink communication and a dedicated configuration for L2 U2N relay, to an L2 U2N Relay UE 220 via an RRC (e.g., RRCReconfiguration) message in operation 231. In addition, a base station 230 may broadcast an SIB (SystemInformationBlock) message in operation 232, or may receive an SIB transmission request from a UE and transmit, to the L2 U2N Relay UE 220, information whether the base station 230 supports layer 2 (L2) U2N relay, a common configuration for sidelink communication, and a common configuration for L2 U2N relay. The common and dedicated configurations for sidelink communication may include a Tx pool and an Rx pool indicating resources for transmission and reception of sidelink data, and a discovery Tx pool and a discovery Rx pool indicating resources for transmission and reception of a sidelink discovery message. The common and dedicated configurations for L2 U2N relay may include a configuration (sl-relayUE-config) that designates the conditions for transmission and reception of a discovery message for the UE 220 that supports the operation of an L2 U2N Relay UE. In case that the discovery Tx pool and the discovery Rx pool are configured, transmission or reception of a discovery message of operation 240 by using the corresponding resource pools. Otherwise, transmission or reception may be performed by using a Tx pool and an Rx pool. The transmission and reception of a discovery message of operation 240 may be performed by using a described predetermined resource pool or by using a resource not mentioned in the disclosure. Hereinafter, it is assumed that a UE that transmits a discovery message and a UE that receives a discovery message have the same transmission and reception resource pool.

In operation 221, depending on a reference signal received power (RSRP) measurement result associated with a serving base station, the L2 U2N Relay UE 220 may determine discovery message transmission or reception of operation 240 for transferring information to the neighboring L2 U2N Remote UE 210 that desires to receive a U2N relay service. In addition, the RSRP reference may be determined based on an RRC (e.g., RRCReconfiguration) message 231 or SIB message 232 received from the base station 230. Specifically, in case that a value obtained based on an RSRP measurement result associated with the base station 230 and hysteresis is less than a threshold, information associated with at least one of threshHighRelay and hystMaxRelay may be included so that a discovery message is transmitted or received in operation 240. In addition, in case that a value obtained based on an RSRP measurement result associated with the base station 230 and hysteresis is more than a threshold, information associated with at least one of threshLowRelay and hystMinRelay may be included so that a discovery message is not transmitted or received in operation 240.

The base station 230 may transmit a dedicated configuration for sidelink communication and a dedicated configuration for L2 U2N relay to the L2 U2N Remote UE 210 via an RRC (e.g., RRCReconfiguration) message in operation 233. The base station 230 may broadcast an SIB (SystemInformationBlock) message in operation 234, or may transmit, to the L2 U2N Remote UE 210 in response to an SIB transmission request from a UE, information whether the base station 230 supports layer 2 (L2) U2N relay, a common configuration for sidelink communication, and a common configuration for L2 U2N relay. In addition, in the state of out-of-coverage (OOC) state, the L2 U2N Remote UE 210 may use a configuration for sidelink communication and a configuration for L2 U2N relay which may be included in Pre-configuration 211 configured in advance. The common and dedicated configurations for sidelink communication and the Pre-configuration 211 may include a Tx pool and an RX pool indicating resources for transmission and reception of sidelink data, and a discovery TX pool and a discovery Rx pool indicating resources for transmission and reception of a sidelink discovery. The common and dedicated configurations for L2 U2N relay may include a configuration (sl-RemoteUE-Config) indicating the conditions for transmission and reception of a discovery message of operation 240 for the UE 210 that supports the operation of a U2N Remote UE. In operation 212, an RSRP reference for the serving base station 230 with which the U2N Remote UE 210 performs transmission or reception of a discovery message of operation 240 may be configured for the L2 U2N Remote UE 210 via an RRC (e.g., RRCReconfiguration) message or SIB message received from the base station 230. Specifically, in case that a value obtained based on an RSRP measurement result associated with the base station 230 and hysteresis is less than a threshold, threshHighRemote and hystMaxRemote may be included so that a discovery message is transmitted or received in operation 240. In the case of OOC, the L2 U2N Remote UE 210 may always transmit and receive a discovery message in operation 240. In a measurement report transmitted to the base station 230, the L2 U2N Remote UE 210 may include a result of measurement of a discovery message transmitted from the L2 U2N Relay UE 220 as an SD-RSRP, and may include a result of measurement of sidelink data transmitted from the L2 U2N Relay UE 220 as an SL-RSRP.

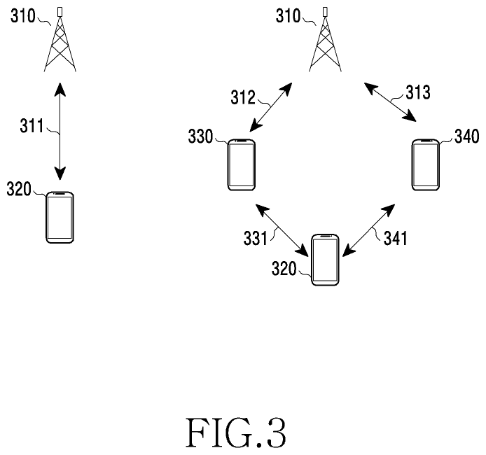

FIG. 3 is a diagram illustrating configuring a direct-path and an indirect-path of a UE-network relay according to an embodiment of the disclosure.

Referring to FIG. 3, an L2 U2N Remote UE 320 may perform direct communication with a base station 310 via a Uu link 311, and in this instance, the Uu link 311 that communicates with the base station 310 may be referred to as a direct-path. In addition, the L2 U2N Remote UE 320 may communicate with the base station 310 via an L2 U2N Relay UE 330. A PC5 link 331 between the L2 U2N Remote UE 320 and the L2 U2N Relay UE 330 or a Uu link, an indirect-path 312, between the L2 U2N Relay UE 330 and the base station 310 may be referred to as an indirect-path. The base station 310 may configure a measurement configuration with respect to the L2 U2N Remote UE 320 in order to receive a wireless measurement result associated with a neighboring NR cell of the L2 U2N Remote UE 320 or a wireless measurement result associated with the neighboring U2N Relay UE 340 via a measurement report transmitted from the L2 U2N Remote UE 320. The base station 310 may receive a measurement report transmitted from the L2 U2N Remote UE 320, and, based on the measurement result, may proceed with a direct-to-indirect-path switch procedure that changes the L2 U2N Remote UE 320 from the direct-path, the Uu link 311, to the indirect-path 312 and 331 or may proceed with an indirect-to-direct-path switch procedure that changes the indirect-path 312 and 331 to the direct-path, the Uu link 311. In addition, the base station 310 may proceed with an indirect-to-indirect-path switch procedure that changes the indirect-path 312 and 331 to another indirect-path 313 and 341.

In the OOC situation in which the L2 U2N Remote UE 320 happens to move to a coverage edge of a base station or beyond the coverage area of the base station, the L2 U2N Remote UE 320 may receive a service via an indirect path without disconnection of the service by performing a direct-to-indirect-path switch procedure that changes to an indirect path via the L2 U2N Relay UE 330 and 340. In addition, in case that the L2 U2N Remote UE 320 moves close to the center of the coverage area of a serving base station or another base station, the L2 U2N Remote UE 320 may receive a service via an indirect-to-direct-path switch procedure that changes to a direct path again. In addition, a service may be continuously provided (service continuity) via an indirect-to-indirect-path switch procedure that changes to an indirect path of another L2 U2N Relay UE 340 while the L2 U2N Remote UE 320 is receiving a service via an indirect path via the serving L2 U2N Relay UE 330.

Although path switching in the single base station 310 has been described as an example, indirect-to-direct-path switching to another base station, direct-to-indirect-path switching to an L2 U2N Relay UE served by another base station, and indirect-to-indirect-path switching to an L2 U2N Relay UE served by another base station may also be supported for service continuity of UE-to-network relay. A measurement report procedure for determining path switching and a path switch procedure will be described below with reference to other drawings.

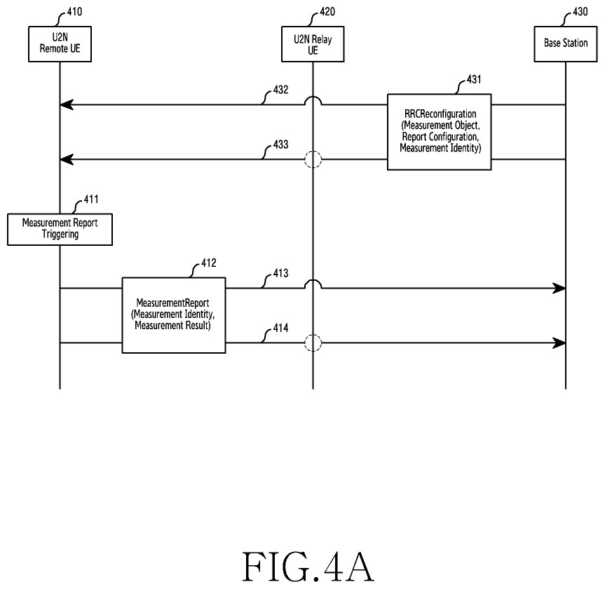

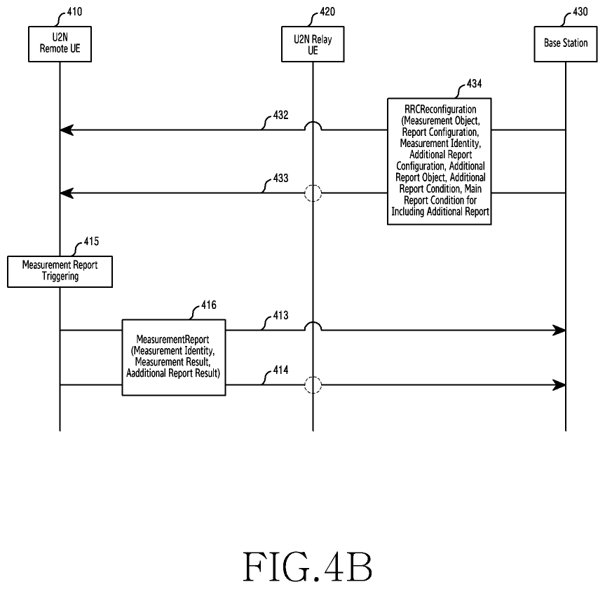

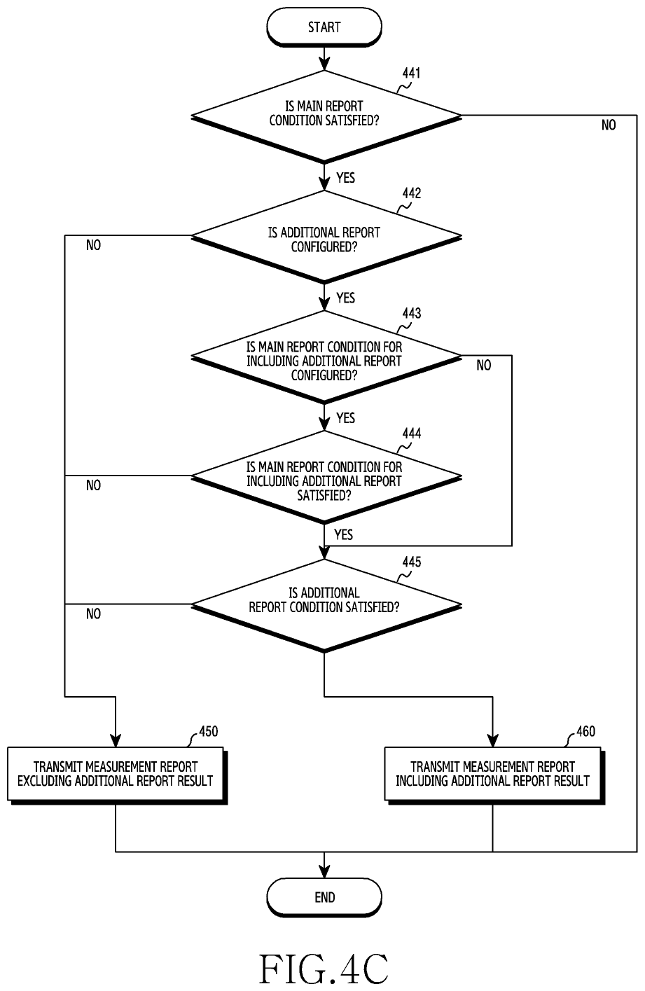

FIGS. 4A, 4B, and 4C are diagrams illustrating a measurement reporting for inter-base station path switching in UE-to-network relay according to various embodiments of the disclosure.

FIG. 4A is a diagram illustrating a base station configuring a measurement configuration with respect to a U2N Remote UE and receives a measurement report according to an embodiment of the disclosure.

Referring to FIG. 4A, a base station 430 may transmit an RRC (e.g., RRCReconfiguration) message in operation 431 to an L2 U2N Remote UE 410 via a direct link 432, or may transmit the same via an indirect link 433 by using an L2 U2N Relay UE 420. In addition, the base station 430 may configure a measurement configuration in order to receive a measurement result of the L2 U2N Remote UE 410. The base station 430 according to various embodiments of the disclosure may be a serving base station, and the serving base station 430 may be a base station including a primary cell (PCell), a primary secondary cell (PSCell), or a special cell (SpCell) that performs transmission and reception of the RRCReconfiguration message in operation 431 with the L2 U2N Remote UE 410 via the direct link 432 or the indirect link 433. A neighboring base station and a target base station may be other base stations different from a serving base station. In addition, the serving L2 U2N Relay UE 420 may be an L2 U2N Relay UE that constitutes the indirect link 433 used when the L2 U2N Remote UE 410 communicates with the serving base station 430, and a neighboring L2 U2N Relay UE and a target L2 U2N Relay UE may be other L2 U2N Relay UEs different from a serving L2 U2N Relay UE. Hereinafter, NR and a sidelink will be described, however, a method described in the disclosure is not limited to the above-mentioned combination and the embodiment may be applicable to other communication systems that have similar technical backgrounds or channel forms.

A measurement configuration may include at least one of a measurement object, a report configuration, and a measurement identity.

The measurement object may include information for measuring an object including at least one of NR, EUTRA, UTRA-FDD, and a sidelink. An NR measurement object may include at least one of a frequency for measuring an NR cell, a subcarrier spacing (SCS), a reference signal configuration (RSS), an allowed/excluded cell list, an object specific offset, and a cell specific offset, and may be configured in the form of measObjectNR. In addition, a sidelink measurement object may include SL-MeasObject including a frequency for measuring a sidelink UE and a sidelink measurement object identity (SL-MeasObjectId) that is in one-to-one correspondence with the frequency and is unique for each UE, and may be configured in the form of measObjectRelay. measObjectNR or measObjectRelay may be in one-to-one correspondence with a measurement object identity, and the measurement object identity may be configured in the form of measObjectId that is unique for each UE and thus, different measurement objects may be distinguished.

A report configuration may be configured by including an event trigger configuration in a report type. An event trigger configuration may include a parameter for determining an entering condition and a leaving condition for an event defined in 3GPP TS 38.331, and may include at least one threshold, an offset, time to trigger (TTT), and hysteresis. In addition, a report interval, a report amount, a cell report measurement unit (report quantity cell), and a relay report measurement unit (report quantity relay) may be included in the event trigger configuration. A report configuration may be in one-to-one correspondence with a report configuration identity, and the report configuration identity may be configured in the form of reportConfigId that is unique for each UE and thus, different report configurations may be distinguished.

A measurement identity may be associated with one measObjectId and one reportConfigId, and may be in one-to-one correspondence. For example, in the case of a single measurement identity, a combination of one measObjectId and one reportConfigId may be expressed in the form of measId that is unique for each UE and thus, different measurement identities may be distinguished.

The L2 U2N Remote UE 410 may obtain an layer-1 measurement result and layer-1 filtering result associated with a Uu link or a PC5 link of another sidelink UE or an NR cell according to requirements of 3GPP TS 38.133 and a procedure of 3GPP TS 38.300, by using a reference signal configured in the measurement configuration. In the case of the layer-1 filtering result, layer-3 filtering may be performed during beam consolidation/selection and TTT to obtain quality of a Uu link or a PC5 link according to the procedure of 3GPP TS 38.331. Subsequently, the L2 U2N Remote UE 410 may evaluate the quality of the Uu link or PC5 link in order to transmit a measurement result based on a report configuration. The layer-1 measurement method and layer-1 filtering associated with a PC5 link and a Uu link are performed according to implementation by a UE and the requirements of 3GPP TS 38.133. The beam consolidation/selection and layer-3 filtering procedure for obtaining a Uu link or PC5 link measurement result for evaluation may be performed according to 3GPP TS 38.331. In addition, a cell quality or PC5 quality after layer-3 filtering may be interchangeably used with a term, such as a Uu link measurement result, a PC5 link measurement result, and or the like. In addition, via a discovery message or a PC5-RRC message, the L2 U2N Remote UE may receive a Uu link measurement unit and measurement result associated with a serving cell of the L2 U2N Relay UE that is measured by the L2 U2N Relay UE.

The measurement result may be expressed as an absolute value or a relative value, and the measurement result may be rounded off or may be expressed to be different from an actually measured value according to an index based on a range.

In case that evaluation in operation 411 indicates that the Uu link or PC5 link measurement result satisfies a measurement report triggering evaluation condition and an entering or leaving condition based on a report configuration, the L2 U2N Remote UE 410 may transmit a measurement report message 412 to the serving base station 430 via a direct link 413 or an indirect link 414. In the case of the Uu link or PC5 link measurement result, RSRP, RSRQ, SINR, SD-RSRP, SL-RSRP, or CBR configured in a report quantity cell or report quantity relay or report quantity sidelink may be used, and a measurement result obtained for each cell, in a unit of a sidelink UE, in a unit of an SSB, in a unit of a CSI-RS may be used. In addition, the distance between a measured UE and a reference location and an interference value of a measured UE may be used. Measurement for each quantity may be performed according to the requirements of 3GPP TS 38.133 and the definitions in 3GPP TS 38.331. The measurement report triggering condition may be based on the definitions and procedures in 3GPP TS 38.331, and at least one condition among a condition that a Uu link or PC5 link measurement result of a measured UE be greater than or less than a threshold, a condition that a difference in Uu link measurement results between a Uu link and another Uu link be greater than or less than an offset, a condition that a difference in PC5 link measurement results between a PC5 link and another PC5 link be greater than or less than an offset, a condition that a difference between the location of a measured UE and a reference location be greater than or less than a threshold according to a Uu link measurement result associated with a serving cell that is measured in association with a discovery message by a UE having a PC5 link measurement result, and a condition that an interference of a measurement UE be greater than or less than a threshold may be combined and configured as the entering or leaving condition. Furthermore, in association with a Uu link measurement result, configuration may be performed so that a measurement result associated with a serving cell, a PSCell, an SpCell, an SCell, or other cells may be used for evaluation. In association with a PC5 link measurement result, configuration may be performed so that a measurement result associated with the serving L2 U2N Relay UE 420 or another L2 U2N Relay UE may be combined and used for evaluation. In this instance, a serving cell, PSCell, SpCell, SCell, and serving L2 U2N Relay UE with which the measured UE performs communication via a Uu link or a PC5 link may be included in the measurement report triggering condition even without designation by a measurement object. Each measurement result may be evaluated by increasing or decreasing a result value according to an object specific offset and a cell specific offset included in the measurement configuration, and evaluation may be performed based on the entering or leaving condition based on an additional value based on hysteresis. The measurement report triggering evaluation condition may be expressed in the form of a report triggering event.

The measurement report message 412 may include a measurement identity of a measurement configuration that triggers the measurement report, one or more Uu link measurement results that satisfy a report condition evaluation, and one or more PC5 link measurement results that satisfy a report condition evaluation. Specifically, a Uu link measurement result may include one or more pieces of information among a serving cell index of a measured cell, a cell identity of a measured cell, a physical cell identity of a measured cell, a unit of measurement used for evaluating a report condition, and a measurement result used for evaluating a report condition. A PC5 link measurement result may include one or more pieces of information among a serving cell identity of a measured L2 U2N Relay UE, a serving cell PLMN identity of a measured L2 U2N Relay UE, a source identity of a measured L2 U2N Relay UE, a unit of measurement used for evaluating a report condition, a measurement result used for evaluating a report condition, a unit of Uu link measurement associated with a serving cell of a L2 U2N Relay UE measured by the L2 U2N Relay UE, and a Uu link measurement result associated with a serving cell of a L2 U2N Relay UE measured by the L2 U2N Relay UE.

FIG. 4B is a diagram illustrating additional information in a measurement report and transmitting the same according to an embodiment of the disclosure.

As described in FIG. 4A, referring to FIG. 4B, in case of a single measurement identity, a combination of one measObjectId and one reportConfigId is expressed in the form of measId that is unique for each UE and thus, different measurement identities may be distinguished. In addition, a measurement report may include a measurement identity of a measurement configuration that triggers the measurement report. Therefore, a single measurement report may include a value that is evaluated based on one measObjectId and one reportConfigId, and is reported. In case that there are two or more frequencies that need to be measured by a UE that performs reporting or two or more evaluation conditions, to receive merely a single measurement report may provide insufficient information for a serving base station to determine various operations including path switch, handover, secondary cell group addition and modification, and secondary cell addition and modification. To receive various measurement reports required for making such decisions, an additional configuration and a delay time may be incurred until the measurement reports are received. Therefore, a method of including various pieces of information requested by a base station in a single measurement report may reduce a delay time and a signaling overhead.

Referring to FIG. 4B, via the direct link 432 or the indirect link 433, the base station 430 may transmit an RRC (e.g., RRCReconfiguration) message in operation 434 including a configuration for including additional information (an additional report) in a measurement report that a UE transmits. In case that evaluation in operation 411 indicates that the Uu link or PC5 link measurement result satisfies a measurement report triggering evaluation condition and an entering or leaving condition based on a report configuration, the L2 U2N Remote UE 410 may transmit the measurement report message 412 to the serving base station 430 via the direct link 413 or the indirect link 414.

Hereinafter, the report condition and the report result associated with a measurement identity described in FIG. 4A are described as terms, main report condition and main report result, respectively, and a report condition and a report result based on an additional configuration are described as terms, additional report condition and additional report result, respectively.

Configuration method 1: For an additional report, a base station may configure, for a measurement identity, one or more pieces of information among the following.
An additional report configuration: a configuration to include a Uu link measurement result in an additional report result or to include a PC5 link measurement result to an additional report result, which may be provided in a form indicating application or non-application, or in the form of a list or a single value including one or more among an additional report object or an additional report condition.
An additional report object, measObjectId, i.e., in the form of a list or a single value of measObjectId.
An object of additionally report, SL-measObjectId, i.e., in the form of a list or a single value of SL-measObjectId.
An additional report condition, reportConfigId, i.e., in the form of a list or a single value of reportConfigId.
A main report condition for including an additional report, reportConfigId, i.e., in the form of a list or a single value of reportConfigId.

Configuration method 2: to configure a measurement object for an additional report, a base station may configure, for a measurement object, one or more pieces of information for a main report among the following.
An additional report configuration: a configuration to include a Uu link measurement result in an additional report result or to include a PC5 link measurement result to an additional report result, which may be provided in a form indicating application or non-application, or in the form of a list or a single value including an additional report object.
An additional report object: an NR measurement object identity, i.e., in the form of a list or a single value of measObjectid.
An additional report object: a sidelink measurement object identity, i.e., in the form of a list or a single value of SL-MeasObjectId.
An additional report object: a parameter included in an NR measurement object, i.e., in the form of a list or a single value of at least one parameter among a frequency for measuring an NR cell, a subcarrier spacing, a reference signal configuration, an allowed/excluded cell list, an object specific offset, and a cell specific offset.
An additional report object: a parameter included in a sidelink measurement object, i.e., in the form of a list or a single value of at least one parameter among sl-MeasObject including a frequency for measuring a sidelink UE, a sidelink measurement object identity that is in one-to-one correspondence with the frequency and is unique for each UE.

Configuration method 3: to configure a report configuration for an additional report, a base station may configure, for a report configuration for a main report, one or more pieces of information among the following.
Additional report configuration: a configuration to include a Uu link measurement result in an additional report result or to include a PC5 link measurement result to an additional report result, which may be provided in a form indicating application or non-application, or in the form of a single value or a list including one or more among an additional report object or an additional report condition.
An additional report object: an NR measurement object identity, i.e., in the form of a list or a single value of measObjectid.
An additional report object: a sidelink measurement object identity, i.e., in the form of a list or a single value of SL-MeasObjectId.
An additional report object: an NR measurement object, i.e., in the form of a list or a single value of measObject.
An additional report object: a sidelink measurement object, i.e., in the form of a list or a single value of SL-MeasObject.
An additional report condition: one or more report configuration identities, i.e., in the form of list or a single value of reportConfigId.
An additional report condition: provided in the form of a report triggering event, or includes at least one piece of information among one or more thresholds, an offset, a TTT, a hysteresis, a report quantity cell, and a report quantity relay, and an evaluation condition may be configured as an evaluation condition described in FIG. 2.
Main report condition for including an additional report: provided in the form of a report triggering event, or includes at least one piece of information among one or more thresholds, an offset, a TTT, a hysteresis, a report quantity cell, and a report quantity relay, and an evaluation condition may be configured as an evaluation condition described in FIG. 2B.

A base station may transmit, to a UE, at least one of an additional report configuration, an additional report object, an additional report condition, and a main report condition for including an additional report via the RRC (e.g., RRCReconfiguration) message in operation 434 by using at least one of methods 1, 2, and 3. In case that at least one of an additional report object, an additional report condition, and a main report condition for including an additional report is configured, the U2N Remote UE 410 that receives the RRCReconfiguration message in operation 434 may implicitly recognize that an additional report is configured. In operation 415, a measurement report triggering event is performed by the U2N remote UE 410.

In case that an additional report result is included in the measurement report of operation 416 that the U2N Remote UE 410 reports to the base station 430, a measurement identity of a measurement configuration in which an additional report is configured, one or more Uu link measurement results that satisfy an additional report condition evaluation, and one or more PC5 link measurement results that satisfy an additional report condition evaluation may be included. Specifically, a Uu link measurement result may include one or more pieces of information among a serving cell index of a measured cell, a cell identity, a physical cell identity, a unit of measurement used for evaluating an additional report condition, and a measurement result used for evaluating an additional report condition, and a PC5 result link measurement result may include one or more pieces of information among a serving cell identity of a measured UE, a serving cell PLMN identity, a source identity, a unit of measurement used for evaluating an additional report condition, a measurement result used for evaluating an additional report condition, a unit of Uu link measurement associated with a serving cell of an L2 U2N Relay UE measured by the L2 U2N Relay UE, and a Uu link measurement result associated with a serving cell of an L2 U2N Relay UE measured by the L2 U2N Relay UE.

FIG. 4C is a diagram illustrating a measurement reporting operation by an L2 U2N Remote UE according to an embodiment of the disclosure. Specifically, there is provided an example in which an L2 U2N Remote UE evaluates, based on a main report condition, a Uu link measurement result or a PC5 link measurement result, and includes, based on an evaluation result of an additional report condition, an additional report result in a measurement result when transmitting the measurement result.

Referring to FIG. 4C, the L2 U2N Remote UE may determine whether a Uu link or PC5 link measurement result satisfies a main report condition in operation 441. In case that the Uu link or PC5 link measurement result satisfies an evaluation based on the main report condition, the L2 U2N Remote UE proceeds with operation 442 so as to determine whether an additional report is configured.

The L2 U2N Remote UE may determine whether an additional report is configured in operation 442. In case that an additional report is not configured, the L2 U2N Remote UE may proceed with operation 450 and may transmit a measurement result excluding an additional report result to a serving base station. In case that an additional report is configured, the L2 U2N Remote UE may proceed with operation 443, and may determine whether a main report condition for including an additional report is configured.

The L2 U2N Remote UE may determine whether a main report condition for including an additional report is configured in operation 443. In case that a main report condition for including an additional report is not configured, the L2 U2N Remote UE may proceed with operation 445 and may evaluate an additional report condition. In case that a main report condition for including an additional report is configured, the L2 U2N Remote UE may proceed with operation 444 and may evaluate the main report condition for including an additional report.

The L2 U2N Remote UE may evaluate whether a measurement result satisfies the main report condition for including the additional report is satisfied in operation 444. In case that the main report condition for including the additional report is not satisfied, the L2 U2N Remote UE may proceed with operation 450 and may transmit a measurement result that excludes an additional report result to the serving base station. In case that the main report condition for including the additional report is satisfied, the L2 U2N Remote UE may proceed with operation 445 and may evaluate the additional report condition.

The L2 U2N Remote UE may evaluate an additional report condition in operation 445. In case that the additional report condition is not satisfied, the L2 U2N Remote UE may proceed with operation 450 and may transmit a measurement result that excludes the additional report result to the serving base station. In case that the additional report condition is satisfied, the L2 U2N Remote UE may proceed with operation 460 and may transmit a measurement result that includes the additional report result to the serving base station.

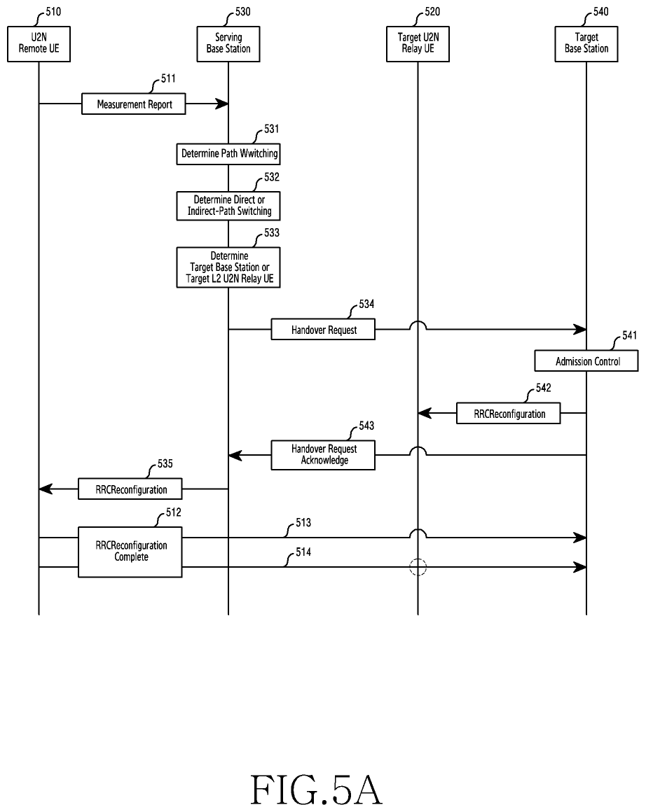

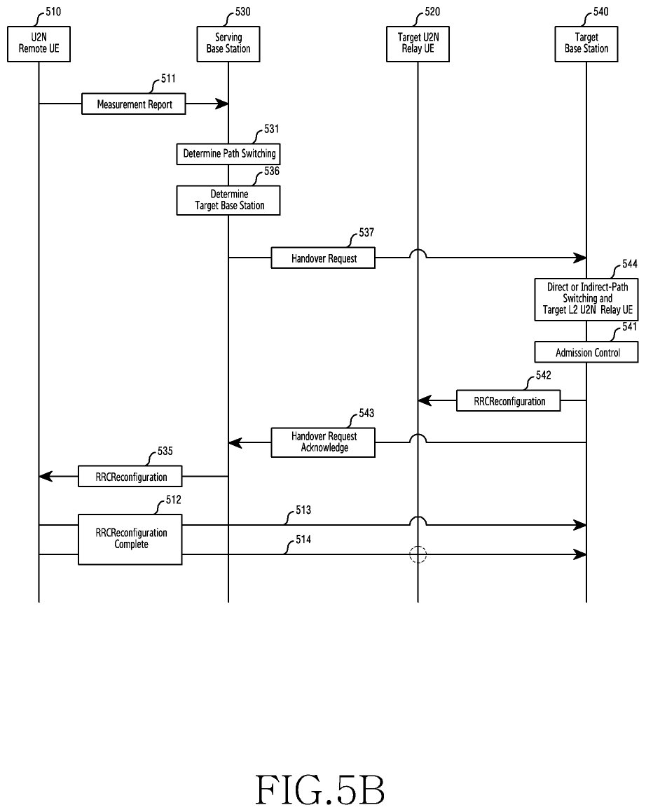

FIGS. 5A and 5B are diagrams illustrating an inter-base station path switching operation in UE-to-network relay according to various embodiments of the disclosure.

As illustrated in FIGS. 4A to 4C, referring to FIGS. 5A and 5B, a serving base station of an L2 U2N Remote UE may receive measurement results associated with one or more L2 U2N Relay UEs or measurement results associated with one or more neighboring base stations respectively or parallelly via one or more measurement reports that the L2 U2N Remote UE transmits via a direct-path or an indirect-path.

Referring to FIG. 5A, based on a measurement report 511 received via a direct or indirect path, a serving base station 530 of the L2 U2N Remote UE 510 may determine path switching of L2 U2N Remote UE 510 in operation 531, and may determine direct-path switching or indirect-path switching in operation 532. In operation 533, by using a measurement result of the L2 U2N Remote UE 510 in association with another base station and information associated with the other base station, that is, at least one piece of information among load information associated with the other base station, information associated with whether XnAP connection with the other base station is present, a success rate of path switching or handover previously performed with the other base station, the serving base station 530 may determine a target base station 540 that is an object to which the path is to be switched for direct-path switching. In addition, by using the measurement result of the L2 U2N Remote UE 510 in association with the L2 U2N Relay UE and at least one piece of information among reported information associated with a serving base station of the L2 U2N Relay UE, the serving base station 530 may determine a target L2 U2N Relay UE 520 that is an object to which the path is to be switched for indirect-path switching in operation 533, and may determine the serving base station of the target L2 U2N Relay UE 520 as the target base station 540. Hereinafter, the target L2 U2N Relay UE 520 may be an L2 U2N Relay UE that is an object to which the path is to be switched for indirect-path switching among one or more L2 U2N Relay UEs reported by the L2 U2N Remote UE 510. The target base station 540 may be a base station that is an object to which the path is to be switched for direct-path switching among one or more neighboring base stations reported by the L2 U2N Remote UE 510 or may be the serving base station of the target L2 U2N Relay UE 520 that is an object to which the path is to be switched for indirect-path switching.

The serving base station 530 may transmit an XnAP handover request message 534 to the target base station 540 so as to request direct-path switching or indirect-path switching. In case that path switching needs to be performed by using NGAP since an XnAP connection is not configured or for other reasons, the serving base station 530 may transmit an NGAP handover required message to an AMF so as to request direct-path switching to the target base station 540 or indirect-path switching to the target L2 U2N Relay UE 520. In case that direct-path switching is performed, the procedure and the content of the XnAP handover request message 534 may be based on the definitions in 3GPP TS 38.300. In case that indirect-path switching is performed, the XnAP handover request message 534 used for direct-path switching may additionally include indirect-path switching indication information, the identity of the target L2 U2N Relay UE 520, and a measurement result associated with the target L2 U2N Relay UE 520 reported by the L2 U2N Remote UE. Hereinafter, although only a path switching procedure using XnAP is described, the embodiment may be easily modified and applied to a path switching procedure using NGAP. The target base station 540 may distinguish direct-path switching or indirect-path switching via indication information included in the XnAP handover request message 534 received from the serving base station 530, and may determine whether to allow direct or indirect-path switching via admission control in operation 541 based on information recognized by the target base station 540, such as a success rate of path switching or handover previously performed with the serving base station 530, load information of the target base station, quality of a Uu link with the target L2 U2N Relay UE 520, an RRC state of the target L2 U2N Relay UE 520, and the like. In case that path switching is allowed, the target base station 540 may transmit, to the serving base station 530, an XnAP handover request acknowledge message 543 including an RRC transparent container to be transmitted to the L2 U2N Remote UE 510. In the case of indirect-path switching, the target base station 540 may transmit U2N relay configuration information associated with the L2 U2N Remote UE 510 to the target L2 U2N Relay UE 520 via a RRCReconfiguration message 542. In case that the serving base station 530 receives the XnAP handover request acknowledge message 543 from the target base station 540, the serving base station may transmit an RRCReconfiguration message 535 including ReconfigurationWithSync in order to indicate, to the L2 U2N Remote UE 510, direct or indirect-path switching. In case that direct-path switching is indicated to the L2 U2N Remote UE 510, the L2 U2N Remote UE 510 may transmit an RRCReconfigurationComplete 512 to the target base station 540 via a direct-path 513 and may complete path switching. Alternatively, in case that indirect-path switching is indicated, the L2 U2N Remote UE 510 may transmit the RRCReconfigurationComplete message 512 to the target base station 540 via an indirect link 514 of the target L2 U2N Relay UE 520 indicated by the serving base station 530.

FIG. 5B is a diagram illustrating an inter-base station path switching operation in UE-to-network relay according to an embodiment of the disclosure.

Referring to FIG. 5B, based on the received measurement report 511, the serving base station 530 of the L2 U2N Remote UE 510 may determine path switching of the L2 U2N Remote UE 510 in operation 531, and may consider another base station or L2 U2N Relay UE as an object to which the path is switchable. In operation 536, by using a measurement result of the L2 U2N Remote UE 510 in association with another base station and information associated with another base station, that is, at least one piece of information among load information associated with the other base station, information associated with whether an XnAP connection with the other base station is present, a success rate of path switching or handover previously performed with the other base station, and the like, the serving base station 530 may determine the target base station 540 that is an object to which the path is to be switched for direct-path switching. In addition, by using the measurement result of the L2 U2N Remote UE 510 in association with an L2 U2N Relay UE and at least one piece of information among reported information associated with a serving base station of the L2 U2N Relay UE, the serving base station 530 may determine, as the target base station 540, a base station that serves one or more L2 U2N Relay UEs that may be objects to which the path is to be switched for indirect-path switching. In case that the serving base station 530 determines that the single target base station 540 is available for both direct-path switching and indirect-path switching, or determines that the single target base station 540 is available for indirect-path switching, the serving base station 530 may transmit an XnAP handover request message 537 to the target base station 540 so that the target base station 540 determines direct-path switching or indirect-path switching and the target L2 U2N Relay UE 520 in operation 544. Via the XnAP handover request message 537, the serving base station 530 may transfer a request for path switching and information needed for operation 544 for determining direct-path switching or indirect-path switching and the target L2 U2N Relay UE 520. The XnAP handover request message 537 may include one or more pieces of information among measurement results associated with the target base station 540 and the L2 U2N Remote UE 510, measurement results associated with one or more L2 U2N Relay UEs served by the target base station 540 and the L2 U2N Remote UE 510, and identities of one or more L2 U2N Relay UEs served by the target base station 540. Based on the information included in the XnAP handover request message 537 received from the serving base station 530 and one or more pieces of information among information that the target base station 540 recognizes, that is, a success rate of path switching and handover performed previously with the serving base station 530, load information of the target base station 540, the quality of a Uu link with an L2 U2N Relay UE, and radio resource control (RRC) state information of a L2 U2N Relay UE, the target base station 540 may determine, as the target L2 U2N Relay UE 520, an L2 U2N Relay UE among the one or more L2 U2N Relay UEs included in the XnAP handover request message 537 in operation 544. The target base station 540 may select one of direct-path switching or indirect-path switching with respect to the target L2 U2N Relay UE 520 in operation 544. In case that direct or indirect-path switching is allowed by the admission control 541, the target base station 540 may transmit, to the serving base station 530, an XnAP handover request acknowledge message 543 including an RRC transparent container to be transmitted to the L2 U2N Remote UE 510. In the case of indirect-path switching, the target base station 540 may include one or more pieces of information among information indicating that indirect-path switching is determined and the identity of the target L2 U2N Relay UE 520 in the XnAP handover request acknowledge message 543, so as to inform the serving base station 530 that indirect-path switching is to be performed. The target base station 540 may transmit, to the target L2 U2N Relay UE 520, the RRCReconfiguration message 542 including U2N relay configuration information associated with the L2 U2N Remote UE 510. In case that the serving base station 530 receives the XnAP handover request acknowledge message 543 from the target base station 540, the serving base station 530 may transmit, to the L2 U2N Remote UE 510, the RRCReconfiguration message 535 including ReconfigurationWithSync for indicating direct or indirect path switching. In case that direct-path switching is indicated, the L2 U2N Remote UE 510 may transmit the RRCReconfigurationComplete message 512 to the target base station 540 via the direct path 513 and may complete path switching. In case that indirect-path switching is indicated, the L2 U2N Remote UE 510 may transmit the RRCReconfigurationComplete message 512 to the target base station 540 via the indirect link 514 of the target L2 U2N Relay UE 520 indicated by the serving base station 530.

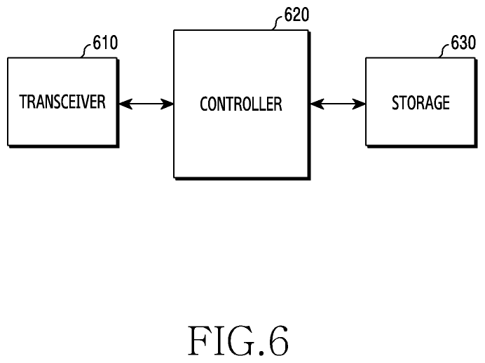

FIG. 6 is a diagram illustrating a structure of a base station according to an embodiment of the disclosure.

Referring to FIG. 6, the base station may include a transceiver 610, a controller (for example, a processor) 620, and a storage 630. According to the above-described communication method of the base station, the transceiver 610, the controller 620, and the storage 630 may operate. A network device may also correspond to the structure of a base station. However, the component elements of the base station are not limited to the above-descried example. For example, the base station may include more or fewer component elements than the above-described component elements. For example, the base station may include the transceiver 610 and the controller 620. In addition, the transceiver 610, the controller 620, and the storage 630 may be configured as a single chip.

The transceiver 610 is the collective name for the receiver of the base station and the transmitter of the base station, and may be capable of performing signal transmission or reception with a UE, another base station, or other network devices. The signal transmitted or received by the base station may include control information and data. The transceiver 610 may transmit, for example, system information to a UE, and may transmit a synchronization signal or a reference signal. To this end, the transceiver 610 may include an RF transmitter that up-converts and amplifies the frequency of a transmitted signal, an RF receiver that low-noise amplifies a received signal and down-converts a frequency of a received signal, and the like. This is merely an example of the transceiver 610, and the component elements of the transceiver 610 are not limited to an RF transmitter and an RF receiver. In addition, the transceiver 610 may include a wired and wireless transceiver, and may include various configurations for transmitting or receiving a signal. In addition, the transceiver 610 may receive a signal via a communication channel (e.g., a wireless channel) and output the same to the controller 620, and may transmit a signal output from the controller 620 via a communication channel. In addition, the transceiver 610 may receive a communication signal and may output the same to a processor, and may transmit a signal output from the processor to a UE, another base station, or other entities via a wired or wireless network.

The storage 630 may store a program and data needed when the base station operates. In addition, the storage 630 may store control information or data included in a signal obtained by the base station. The storage 630 may be embodied as a storage medium, such as read only memory (ROM), a random access memory (RAM), a hard disk, a compact disc-ROM (CD-ROM), a digital versatile discs (DVD), and the like, or a combination of storage media. The storage 630 may store at least one piece of information among information transmitted or received via the transceiver 610 and information produced by the controller 620.

In the disclosure, the controller 620 may be defined as a circuit, an application-specific integrated circuit, or at least one processor. A processor may include a communication processor (CP) that performs control for communication, and an application processor (AP) that controls a higher layer, such as an application program or the like. The controller 620 may control overall operation of the base station according to the embodiments of the disclosure. For example, the controller 620 may control a signal flow among blocks so that operations based on the above-described flowcharts are performed.

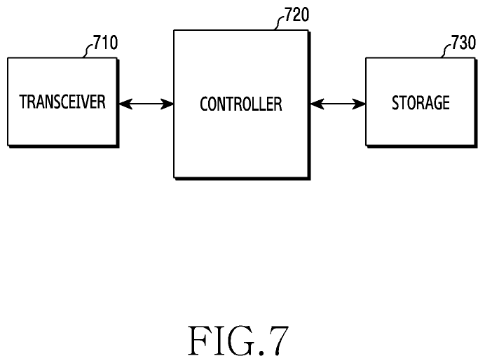

FIG. 7 is a diagram illustrating a structure of a user equipment (UE) according to an embodiment of the disclosure.

Referring to FIG. 7, the UE may include a transceiver 710, a controller (for example, a processor) 720, and a storage 730. According to the above-described communication method of the UE, the transceiver 710, the controller 720, and the storage 730 may operate. However, the component elements of the UE are not limited to the above-descried example. For example, the UE may include more or fewer component elements than the above-described component elements. For example, the UE may include the transceiver 710 and the controller 720. In addition, the transceiver 710, the controller 720, and the storage 730 may be configured as a single chip.

The transceiver 710 is the collective name for the receiver of the UE and the transmitter of the UE, and may be capable of performing signal transmission or reception with a UE, another UE, or a network entity. The signal transmitted or received by the base station may include control information and data. The transceiver 710 may receive, for example, system information from a base station, and may receive a synchronization signal or a reference signal. To this end, the transceiver 710 may include an RF transmitter that up-converts and amplifies the frequency of a transmitted signal, an RF receiver that low-noise amplifies a received signal and down-converts a frequency of a received signal, and the like. This is merely an example of the transceiver 710, and the component elements of the transceiver 710 are not limited to an RF transmitter and an RF receiver. In addition, the transceiver 710 may include a wired and wireless transceiver, and may include various configurations for transmitting or receiving a signal. In addition, the transceiver 710 may receive a signal via a wireless channel and output the same to the controller 720, and may transmit a signal output from the controller 720 via a wireless channel. In addition, the transceiver 710 may receive a communication signal and may output the same to a processor, and may transmit a signal output from a processor to a network entity via a wired or wireless network.

The storage 730 may store a program and data needed when the UE operates. In addition, the storage 730 may store control information or data included in a signal obtained by the UE. The storage 730 may be embodied as a storage medium, such as ROM, RAM, a hard disk, a CD-ROM, a DVD, and the like, or a combination of storage media.

In the disclosure, the controller 720 may be defined as a circuit, an application-specific integrated circuit, or at least one processor. A processor may include a communication processor (CP) that performs control for communication, and an application processor (AP) that controls a higher layer, such as an application program or the like. The controller 720 may control overall operation of the UE according to the embodiments of the disclosure. For example, the controller 720 may control a signal flow among blocks so that operations based on the above-described flowcharts are performed.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks, such as the Internet, intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station (BS) in a wireless communication system, the method comprising:
transmitting, to a user equipment (UE), a radio resource control (RRC) message including measurement configuration information through a direct path or an indirect path via a relay UE; and
receiving, from the UE, a MeasurementReport message including measurement result through the direct path or the indirect path via the relay UE,
wherein the measurement result includes a first measurement result for direction communications (PC5) link and a second measurement result for Uu link.

2. The method of claim 1, wherein the measurement configuration information includes at least one of a measurement object, a report configuration, or a measurement identity.

3. The method of claim 1,
wherein the first measurement result indicates a result that satisfies a first reporting condition for the PC5 link, and
wherein the second measurement result indicates a result that satisfies a second reporting condition for the Uu link.

4. The method of claim 2, wherein, in case that the measurement configuration information includes additional report information for additional measurement, the MeasurementReport message includes an additional measurement result corresponding to the additional report information.

5. A base station (BS) of a hosting network in a wireless communication system, the BS comprising:
a transceiver, and
at least one processor coupled with the transceiver and configured to:
transmit, to a user equipment (UE), a radio resource control (RRC) message including measurement configuration information through a direct path or an indirect path via a relay UE, and
receive, from the UE, a MeasurementReport message including measurement result through the direct path or the indirect path via the relay UE, wherein the measurement result includes a first measurement result for PC5 link and a second measurement result for Uu link.

6. The BS of claim 5, wherein the measurement configuration information includes at least one of a measurement object, a report configuration, or a measurement identity.

7. The BS of claim 5,
wherein the first measurement result indicates a result that satisfies a first reporting condition for the PC5 link, and
wherein the second measurement result indicates a result that satisfies a second reporting condition for the Uu link.

8. The BS of claim 6, wherein, in case that the measurement configuration information includes additional report information for additional measurement, the MeasurementReport message includes an additional measurement result corresponding to the additional report information.

9. A method performed by a user equipment (UE) in a wireless communication system, the method comprising:
receiving, from a base station (BS), a radio resource control (RRC) message including measurement configuration information through a direct path or an indirect path via a relay UE; and
transmitting, to the BS, a MeasurementReport message including measurement result through the direct path or the indirect path via the relay UE,
wherein the measurement result includes a first measurement result for PC5 link and a second measurement result for Uu link.

10. The method of claim 9, wherein the measurement configuration information includes at least one of a measurement object, a report configuration, or a measurement identity.

11. The method of claim 9,
wherein the first measurement result indicates a result that satisfies a first reporting condition for the PC5 link, and
wherein the second measurement result indicates a result that satisfies a second reporting condition for the Uu link.

12. The method of claim 10, wherein, in case that the measurement configuration information includes additional report information for additional measurement, the MeasurementReport message includes an additional measurement result corresponding to the additional report information.

13. A user equipment (UE) in a wireless communication system, the UE comprising:
a transceiver, and
at least one processor coupled with the transceiver and configured to:
receive, from a base station (BS), a radio resource control (RRC) message including measurement configuration information through a direct path or an indirect path via a relay UE, and
transmit, to the BS, a MeasurementReport message including measurement result through the direct path or the indirect path via the relay UE,
wherein the measurement result includes a first measurement result for PC5 link and a second measurement result for Uu link.

14. The UE of claim 13, wherein the measurement configuration information includes at least one of a measurement object, a report configuration, or a measurement identity, and
in case that the measurement configuration information includes additional report information for additional measurement, wherein the MeasurementReport message includes an additional measurement result corresponding to the additional report information.

15. The UE of claim 13,
wherein the first measurement result indicates a result that satisfies a first reporting condition for the PC5 link, and
wherein the second measurement result indicates a result that satisfies a second reporting condition for the Uu link.
